(19) United States
(12) Patent Application Publication
(10) Pub. No.: US 2018/0072397 A1
(43) Pub. Date: Mar. 15, 2018

(54) UNDER FLOORING ARMOR

(71) Applicant: Sikorsky Aircraft Corporation, Stratford, CT (US)

(72) Inventors: Shawn Alexander, Battle Ground, WA (US); Craig Hallquist, Portland, OR (US); Robert N. Plumb, Vancouver, WA (US)

(21) Appl. No.: 15/677,620

(22) Filed: Aug. 15, 2017

Related U.S. Application Data
(60) Provisional application No. 62/376,065, filed on Aug. 17, 2016.

(51) Int. Cl. B64C 1/18; B64C 27/04

(52) U.S. Cl. CPC B64C 1/18; B64C 27/04

(57) ABSTRACT

A vehicle frame system for a vehicle includes a frame, one or more floor armor panels disposed on the frame, and at least one flooring panel disposed over the frame and configured to sandwich the one or more armor panels between the frame and the flooring panel. The vehicle can be an aircraft (e.g., a helicopter), for example.

### CROSS-REFERENCE TO RELATED APPLICATIONS

This application claims the benefit of U.S. Provisional Patent Application No. 62/376,065 filed on Aug. 17, 2016, the entire contents of which is incorporated herein by reference.

### BACKGROUND

### 1. Field

The present disclosure relates to armored vehicles, more specifically to armor structures and systems for armored vehicles (e.g., helicopters).

### 2. Description of Related Art

Current aircraft armor solutions are placed on top of flooring, occupy precious cabin volume, present potential trip hazards, as well as present engineering challenges due to their placement in high use, high traffic areas. Placement in these areas makes them susceptible to general wear as well as damage from numerous sharp and heavy objects typically used in an operational environment.

Such conventional methods and systems have generally been considered satisfactory for their intended purpose. However, there is still a need in the art for improved armor structures and placements. The present disclosure provides a solution for this need.

### SUMMARY

A vehicle frame system for a vehicle includes a frame, one or more floor armor panels disposed on the frame, and at least one flooring panel disposed over the frame and configured to sandwich the one or more armor panels between the frame and the flooring panel. The vehicle can be an aircraft (e.g., a helicopter), for example.

The frame can include a plurality of cross-beams. The one or more floor armor panels can include grooves shaped to receive cross-beams of the frame to mate with the frame.

The frame can include mounting rails. The mounting rails can include a rail armor panel attached (e.g., via bolts or any other suitable attachment) to an underside of the mounting rails. In certain embodiments, one or more of the floor armor panels can overlap with the rail armor panel.

The vehicle frame system can include a stop member disposed between the flooring panel and each armor panel and configured to compress against each armor panel to retain the armor panel against the frame. In certain embodiments, the stop member can include a soft and/or elastic material (e.g., silicone, rubber).

A method includes laying an armor panel on a frame of a vehicle, and securing a flooring panel to the frame over the armor panel such that the armor panel is sandwiched between the frame and the flooring panel. The method can include removing vehicle flooring before laying the armor panel on the frame.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of a portion of an embodiment of a vehicle frame system in accordance with this disclosure, showing armor panels laying on a frame of the vehicle frame system;

FIG. 2 is a perspective view of an embodiment of an armor panel; and

FIG. 3 is a cross-sectional view of a portion of the vehicle frame system of FIG. 1, showing a mounting rail and a rail armor plate being overlapped by a flooring armor plate.

### DETAILED DESCRIPTION

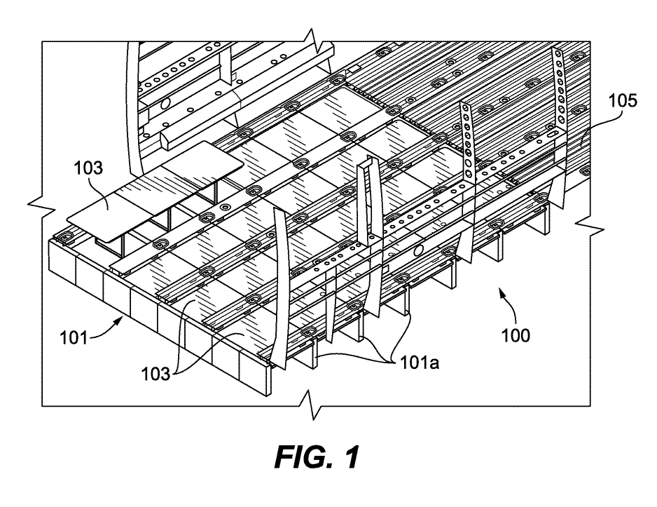

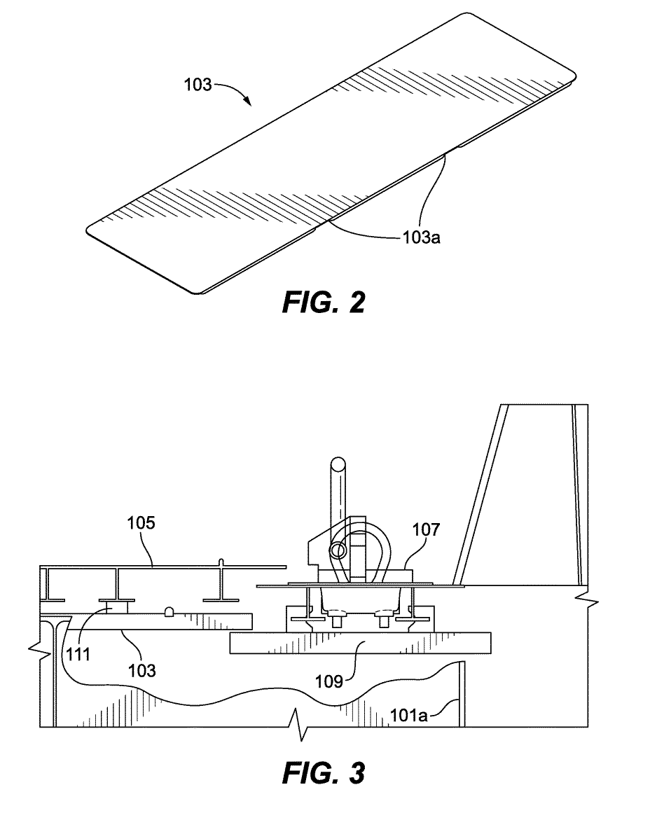

Reference will now be made to the drawings wherein like reference numerals identify similar structural features or aspects of the subject disclosure. For purposes of explanation and illustration, and not limitation, an illustrative view of an embodiment of a vehicle frame system in accordance with the disclosure is shown in FIG. 1 and is designated generally by reference character 100. Other embodiments and/or aspects of this disclosure are shown in FIGS. 2 and 3. The systems and methods described herein can be used to provide efficient armoring arrangements for vehicles (e.g., aircraft).

Referring to FIG. 1, a vehicle frame system 100 for a vehicle includes a frame 101. The vehicle frame system 100 also includes one or more floor armor panels 103 disposed on the frame 101. At least one flooring panel 105 is disposed over the frame 101 and configured to sandwich the one or more armor panels 103 between the frame 101 and the at least one flooring panel 105. The vehicle 100 can be an aircraft (e.g., a helicopter), for example.

The frame 101 can include a plurality of cross-beams 101a. Referring additionally to FIG. 2, the one or more floor armor panels 103 can include grooves 103a shaped to receive the cross-beams 101a of the frame 101 to mate with the frame 101. The grooves 103a can extend across a width of the armor panel 103 and can be sized to snugly receive the cross-beams 101a. Any other suitable shape and/or dimension is contemplated herein. The armor panels 103 can include any suitable armor material (e.g., fiberglass, resin, metal, or the like) and/or any suitable armor structure.

Referring additionally to FIG. 3, the frame 101 can include mounting rails 107. The mounting rails 107 can include a rail armor panel 109 attached (e.g., via bolts or any other suitable attachment) to an underside of the mounting rails 107. In certain embodiments, one or more of the floor armor panels can overlap with the rail armor panel.

The system 100 can include a stop member 111 disposed between the flooring panel 105 and each armor panel 103. The stop member 111 can be configured to compress against each armor panel 103 to retain the armor panel 103 against the frame 101. In certain embodiments, the stop member 111 can include a soft and/or elastic material (e.g., silicone, rubber). However, In certain embodiments, each flooring panel 105 can be dimensioned and/or include suitable features extending therefrom to directly compress the armor panels 103 against the cross-beams 101a.

A method includes laying an armor panel on a frame of a vehicle, and securing a flooring panel to the frame over the armor panel such that the armor panel is sandwiched between the frame and the flooring panel. The method can include removing vehicle flooring before laying the armor panel on the frame.

As described above, embodiments include a bridging under-floor armor system that sits beneath the aircraft floor and bridges between primary aircraft structure. Embodiments move the armor out of the cabin and can utilize existing structure for mounting. Additionally, the system can use the existing aircraft floor to secure the armor in the vertical direction. Embodiments include separate armor panels that can easily be added or removed in the field without the use of special tools (e.g., since they are not attached to the frame and merely retained by the flooring). This allows the user to tailor the coverage of armor protection depending on the mission. Embodiments increase cabin volume and envelope for loading, reduce fluid interactions, and reduce weight of vehicles.

The methods and systems of the present disclosure, as described above and shown in the drawings, provide for armor systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A vehicle frame system, comprising:
a frame;
one or more floor armor panels disposed on the frame; and
at least one flooring panel disposed over the frame and configured to sandwich the one or more floor armor panels between the frame and the flooring panel.

2. The vehicle frame system of claim 1, wherein the vehicle is an aircraft.

3. The vehicle frame system of claim 1, wherein the frame includes a plurality of cross-beams.

4. The vehicle frame system of claim 4, wherein the one or more floor armor panels include grooves shaped to receive cross-beams of the frame to mate with the frame.

5. The vehicle frame system of claim 1, wherein the frame includes mounting rails.

6. The vehicle frame system of claim 5, wherein the mounting rails include a rail armor panel attached to an underside of the mounting rails.

7. The vehicle frame system of claim 6, wherein one or more of the floor armor panels overlap with the rail armor panel.

8. The vehicle frame system of claim 1, further comprising a stop member disposed between the flooring panel and each floor armor panel and configured to compress against each floor armor panel to retain the floor armor panel against the frame.

9. The vehicle frame system of claim 8, wherein the stop member includes a soft and/or elastic material.

10. A method, comprising:
laying an armor panel on a frame of a vehicle; and
securing a flooring panel to the frame over the armor panel such that the armor panel is sandwiched between the frame and the flooring panel.

11. The method of claim 10, further comprising removing vehicle flooring before laying the armor panel on the frame.
